(19) United States
(12) Patent Application Publication
(10) Pub. No.: US 2015/0066793 A1
(43) Pub. Date: Mar. 5, 2015

(54) CORRELATION ENGINE FOR GENERATING ANONYMOUS CORRELATIONS BETWEEN PUBLICATION-RESTRICTED DATA AND PERSONAL ATRIBUTE DATA

(71) Applicant: ADROIT DS, LLC, New York, NY (US)

(72) Inventor: Robert G. Brown, Durham, NC (US)

(73) Assignee: ADROIT DS, LLC, New York, NY (US)

(21) Appl. No.: 14/534,562

(22) Filed: Nov. 6, 2014

Related U.S. Application Data
(63) Continuation of application No. 12/536,765, filed on Aug. 6, 2009, now abandoned.
(60) Provisional application No. 61/087,339, filed on Aug. 8, 2008.

(51) Int. Cl. G06Q 10/06; G06Q 50/26

(52) U.S. Cl. CPC G06Q 10/067; G06Q 50/265
USPC 705/325

(57) ABSTRACT

A correlation engine apparatus includes a network interface and a processor, wherein the correlation engine is configured to receive publication-restricted data and non-publication-restricted data and generate correlations useable for predictive models, wherein no trace of any personal identifying information (PII) in the publication-restricted data exists in the correlations.

This application claims the benefit of U.S. Provisional Patent Application No. 61/087,339 filed Aug. 8, 2008, the contents of which is incorporated by reference herein in its entirety.

### BACKGROUND OF THE INVENTION

The present invention is related to processors for correlating data from different databases, and more specifically to a correlation engine for generating anonymous correlations between publication-restricted data of all forms and non-publication-restricted data.

In the normal course of operation, many businesses and organizations accumulate a vast store of “transactional” information. This information is generally captured in the form of a database or set of databases that contain (for example) records of purchases or other data in a more or less standardized format. Many individuals are represented that possess any given constellation of the common values, generally connected to personal identifying information (PII) such as, for example, names, account numbers, patient identifiers, employee or customer number, or other specific demographic attribute information that could be used in a malicious way either in connection with the transactional data (e.g. improperly denying insurance) or alone (e.g. identity theft).

Modeling this information could very useful for marketing, predicting events, as well as understanding trends, activities, events, occurrences, etc. Currently, this sort of information has not been useable in any modeling process connecting demographic data, lifestyle/preference data, and (protected) transactional or historical data because of the various legal prohibitions preventing the possessor of original data containing PII to build models that use this PII in the “protected” database in any way. Currently, one cannot match up any portion of the demographic attributes of any individual to any particular (desirable, interesting) transactional pattern or condition (e.g., disease) thus making it impossible to use the PII-free protected data in the generation of models connecting transactional patterns to demographic attributes.

Some methods perform matches on for example hashed or encrypted PII data that is nevertheless included in the explicit model generation process. However, no matter how careful one is building the hash and performing the matches, the information content of the PII data is still present by construction in such a process and hence is subject to being decrypted by, for example, brute force attacks. For this reason many risk-averse companies and the general medical establishment refuse to utilize match-based methods even with obfuscated PII because it exposes the private individuals to at least some risk of violation of their privacy without their consent.

Yet there are powerful reasons to want to build models that use the transaction information itself without violating the rights or privacy of the individuals within the database by utilizing their PII, and indeed, to ultimately be able to indirectly connect these patterns to demographic attributes. In healthcare, for example, things learned from large studies (using analysis that ultimately completely discards all PII) save lives, but doing a large scale study that would provide maximally useful information is difficult and expensive as every medical record that contributes to the study must be individually authorized. In business models derived from transactional data often translate directly into increased profits.

Attempts to build models that do utilize data derived from PII-containing sources using traditional modeling techniques and methodology must get permission from each specific individual represented in the model-generation dataset to use them in a traditional model generation process. In both cases, the need to get permission from each individual whose data is ultimately used in an anonymous way adds enormous barriers (higher cost, lower effectiveness, greater risk) to the entire process.

### BRIEF SUMMARY OF THE INVENTION

According to one aspect of the present invention, a correlation engine apparatus includes a network interface and a processor, wherein the correlation engine is configured to receive publication-restricted data and non-publication-restricted data and generate correlations useable for predictive models, wherein no trace of any personal identifying information (PII) in the publication-restricted data exists in the correlations.

According to another aspect of the present invention, a method for generating a predictive model includes receiving transaction data, generating personal identity information (PII) free transaction data by removing any personal identity information contained in the transaction data, generating probability distributions for each transactional category of interest contained in the PII free transaction data, generating joint and conditional probability distributions based on at least two transactional categories, and generating a forward map predictive model P of the joint and conditional probability distributions.

According to a still further aspect of the present invention, a method for generating a predictive model includes identifying matching transaction categories between personal identity information (PII) free transaction data and PII free demographic transaction data, generating probability distributions for all transaction and demographic variables in the matching transaction categories, generating joint and conditional probability distributions based on at least two transaction and demographic variables, and generating a reverse map predictive model Q of conditional probabilities from the matching transaction categories back to the demographic variables.

According to an aspect of the present invention, includes a method for utilizing data in a publication-restricted database in a manner that avoids publication of personal identity information (PII) data, the method includes (a) generating, from the data in the publication-restricted database a set of aggregated multidimensional matrices that represent the population frequency (or estimated joint probability) of individuals in that database participating in selected constellations of transactions or other behaviors, (b) constructing predictive models that target propensity to participate in particular transactions or other behaviors represented in one or more of these linked joint probability constellations, (c) deriving, from the set of joint probability constellations that represent strongly correlated transactions or other behaviors within the publication-restricted database, predictive models for additional, strongly correlated transactions or other behaviors distinct from the particular model constructed in (b), (d) utilizing this set of derived models as input in the construction of additional predictive models that target transactions or other behaviors linked by them, wherein permitting the construction of predictive models by correlating data in the publication-restricted database with individual demographic variables or other attributes found in a separate and distinct database.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for a correlation engine (ACE) according to an exemplary embodiment of the present invention;

FIG. 2 is a forward map according to an exemplary embodiment of the present invention;

FIG. 2 is a flowchart of a process for creating a forward map according to an exemplary embodiment of the present invention;

FIG. 4 is a reverse map according to an exemplary embodiment of the present invention;

FIG. 3 is a flowchart of a process for creating a reverse map according to an exemplary embodiment of the present invention;

FIG. 6 is a unified map according to an exemplary embodiment of the present invention;

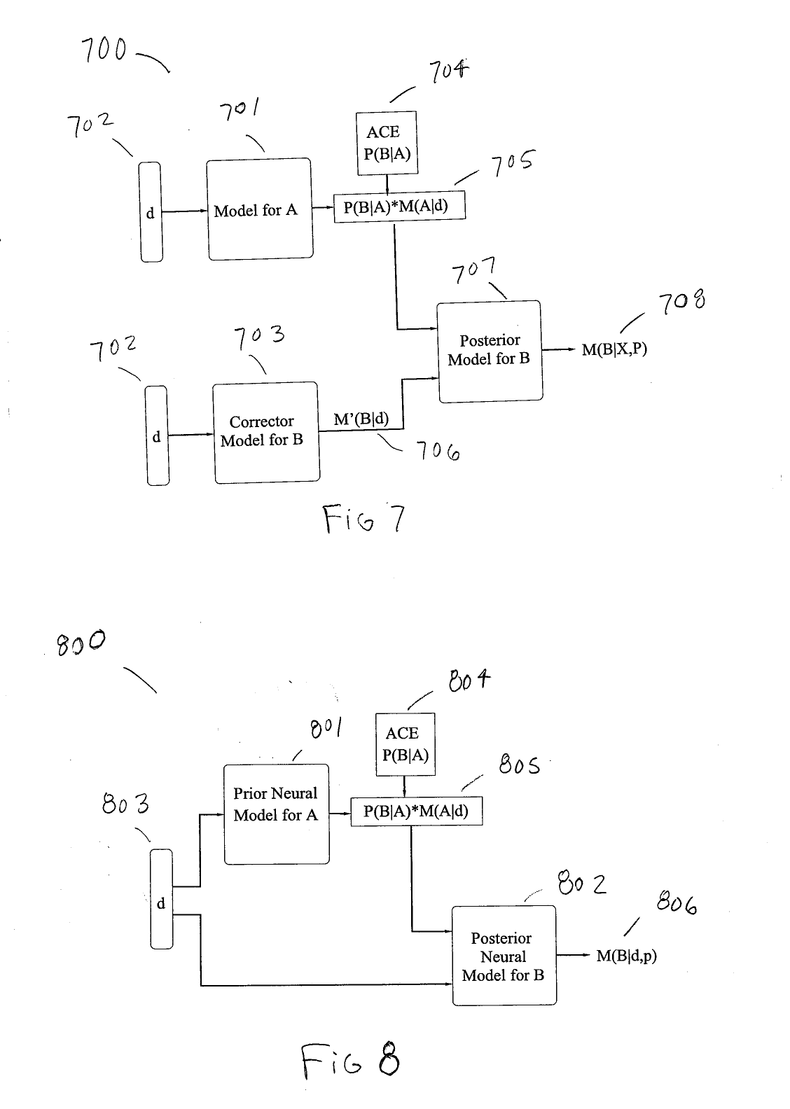

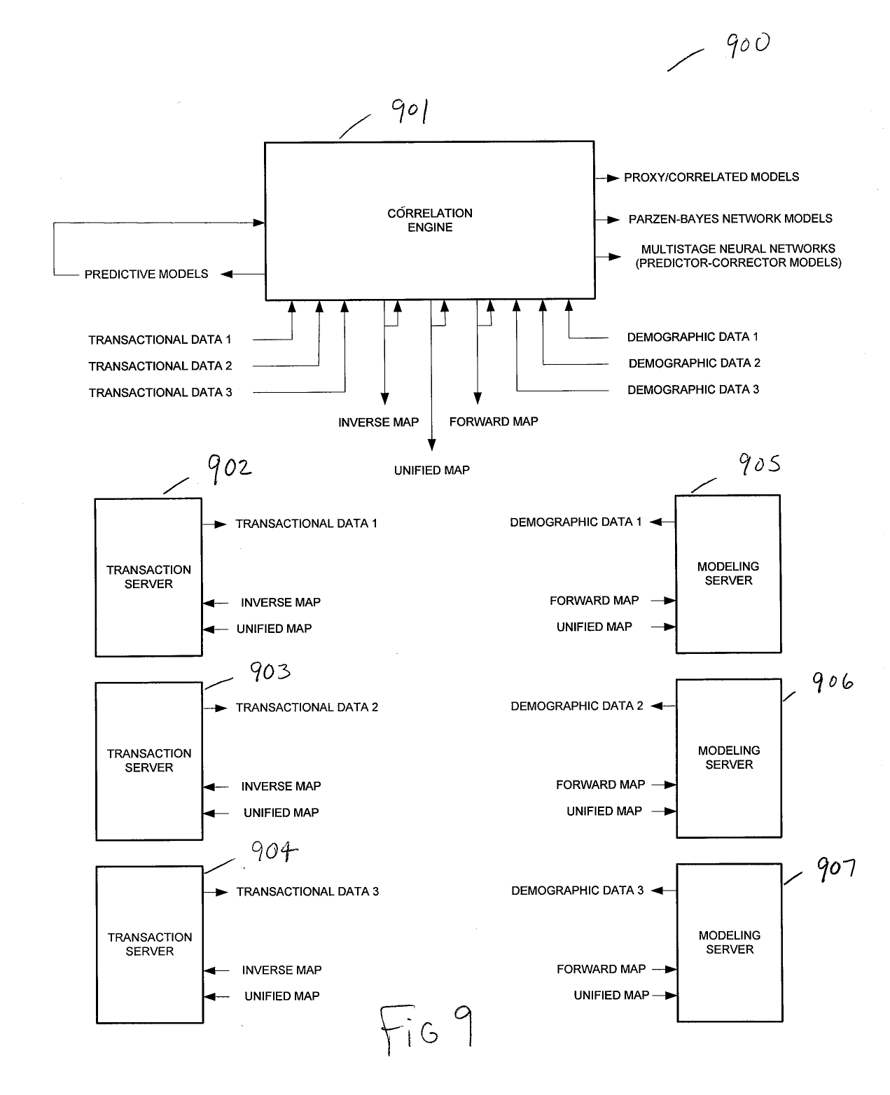

FIG. 4 is a flowchart of a process for creating a unified map according to an exemplary embodiment of the present invention;

FIG. 5 is a flowchart of a process for creating a unified map according to another exemplary embodiment of the present invention;

FIG. 6 is a model for a transactional target according to an exemplary embodiment of the present invention;

FIG. 7 is a diagram of a model for a two stage correlated model according to an exemplary embodiment of the present invention;

FIG. 8 is a diagram of a two-stage neural posterior model according to an exemplary embodiment of the present invention; and

FIG. 9 is a diagram of a system for generating anonymous correlations between publication-restricted data and personal attribute data according to another exemplary embodiment of the present invention.

### DETAILED DESCRIPTION OF THE INVENTION

As will be appreciated by one of skill in the art, the present invention may be embodied as an apparatus, method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

The present invention is related to a correlation engine for generating anonymous correlations between publication-restricted data of all forms and non-publication-restricted data. A common, but not exclusive, example of this is between databases where privacy laws restrict access to personal identifying information and open public demographic databases. To help illustrate embodiments according to the present invention, personal data and individuals will be used. However, embodiments according to the present invention are not limited to databases with this type of information or data. Embodiments according to the present invention may be applied to any private/restricted databases. Embodiments according to the present invention may be useful for the Gramm-Leach-Bliley Act (GLBA) and Health Insurance Portability and Accountability Act (HIPAA), but also may be applied for a variety of applications, e.g. defense applications, where it may be desired to extract publicly usable information from a database with private/security restricted fields, or in business situations where two companies desire to collaborate using certain parts of their databases while keeping other parts private, etc. Embodiments according to the present invention may make sound inferences in one database using a statistical analysis of part of another database without doing a “match” between the two databases and where certain parts of one or the other are restricted and cannot be used. Thus, according to embodiments of the present invention, the forward map, the reverse map, and the unified map connection (discussed following), may be applied to any (>2) databases where one or more of them are partially private and where they have some overlapping statistical scope. The terms “individual” and “PIT” that will be used following are examples, but may also refer to abstractions such as “records in a database” and “concealed or privacy restricted fields” in those records, and are not limited to human beings per se, although for illustration purposes, humans may be referred to in the following exemplary embodiments of the present invention.

Some embodiments according to the present invention enable the use of transactional records, while purging any connection with individuals, and subject them to a model generation process that creates patterns. These patterns are not specific to individuals but are highly approximate descriptors of many individuals. According to embodiments of the present invention, a server, an engine or other apparatus or processing device may accept as input anonymized PII-free demographics-free transactional data and generate an anonymous aggregated correlation matrix/tensor that contains essential information that cannot possibly be uniquely connected to the PII of any individuals that contribute to the transactional records used to build it no matter what brute-force resources are brought to bear for that purpose.

According to embodiments of the present invention, the correlation matrix may be used in various directions. For example, the correlation matrix may be used to improve the accuracy of models built using external non-PII-controlled (e.g. demographic) public data drawn from the general population, such as that collected and provided by third-party vendors or in permissioned medical studies, as long as there is some measure of overlap in the transactional space represented within the matrix with that in the outside dataset. Note that the required overlap is categorical, not individual, i.e., at no time is any individual within the protected dataset matched to any individual in the public dataset. In this case the correlation matrix may be considered a Bayesian prior for computations that estimate probabilities using externally derived transactional data, and if one uses it one will arrive at different (more accurate) conclusions than one might naively arrive at working without it. To help illustrate embodiments of the present invention, this process my be referred to as a forward map from PII-free transactional data to a pure anonymized aggregated correlation matrix used to enhance model generation outside of the security boundaries of the original PII-protected data space.

Moreover, according to embodiments of the present invention, the correlation matrix may also be used in the opposite direction, for example, to associate probable demographic or other attributes with specific transactional patterns identified in the protected space. This, too, has great value, as in many business cases the owner of a transactional record does not even have any actual demographic PII associated with the transactional records, but would like to infer demographic patterns to, e.g. in direct marketing efforts. To help illustrate embodiments of the present invention, this process may be referred to as producing an inverse map that projects estimated demographics back onto demographics-free PII-free transaction data that has the same general data dictionary as the set used to generate the common correlation matrix. In addition, according to embodiments of the present invention, the two maps may be combined into a unified matrix that more or less completely captures the information-theoretic content of all contributing databases. This unified map has a unique value as a very reliable description of the statistical universe represented by all available data.

Embodiments according to the present invention include a computational correlation engine server. For illustrative purposes, this engine may be referred to as a correlation engine, a correlation engine server or an Arcametrics Correlation Engine (ACE). Further, the term “transaction” may be used to encompass any sort of activity or data element that describes events or behavior in a way that can be captured in a database. The ACE executes a series of processes to identify strongly correlated and “valuable” (in a domain-specific sense) projections (aggregations) within the protected but PII-free transactional space and form the joint correlations of this set of projections taken two, three, or more at a time. This matrix is the basis for all forward map modeling processes. Further, the ACE may then optionally execute a series of processes that effectively create a predictive model from external (third party) data that map as close a match as possible to selected transactional patterns represented in the external (non-PII-protected) data to demographics, creating the inverse map. These two maps are now Bayesian priors for the connected behavior on an individual basis, even though no private data from inside the perimeter of the originating institution is ever joined to an individual with a known relationship with that institution, and no individual whose data might have contributed to the model generation process can be identified using either the forward or backwards maps.

In addition, according to embodiments of the present invention, the ACE may be configured to build a unified map that can be used forward or backward with equal ease. This unified map contains all derived knowledge obtained from the contributing statistical data. According to embodiments of the present invention, an ACE server may be configured to generate this data as well as directly utilizing this data in several important ways, most notably the creation of multistage models that use the map data as Bayesian priors to the construction of a predictive model, the construction of proxy models that permit predictive models created with permissioned data to be used for non-permissioned targets that are strongly correlated by the PII-free unified map, and the construction of multistage neural networks that function as Bayesian predictor-corrector models that can dynamically improve traditional model generation methods and yield better results from sparser permissioned data. These illustrative applications are described in more detail below.

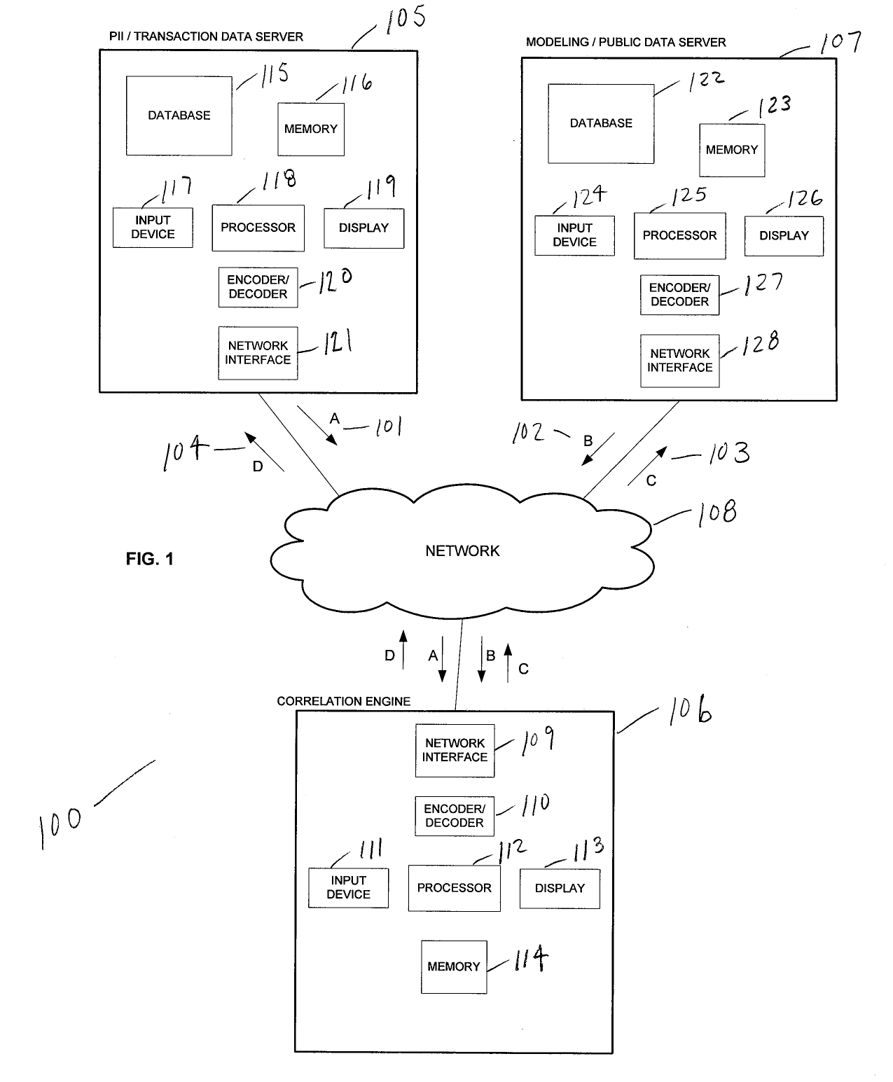

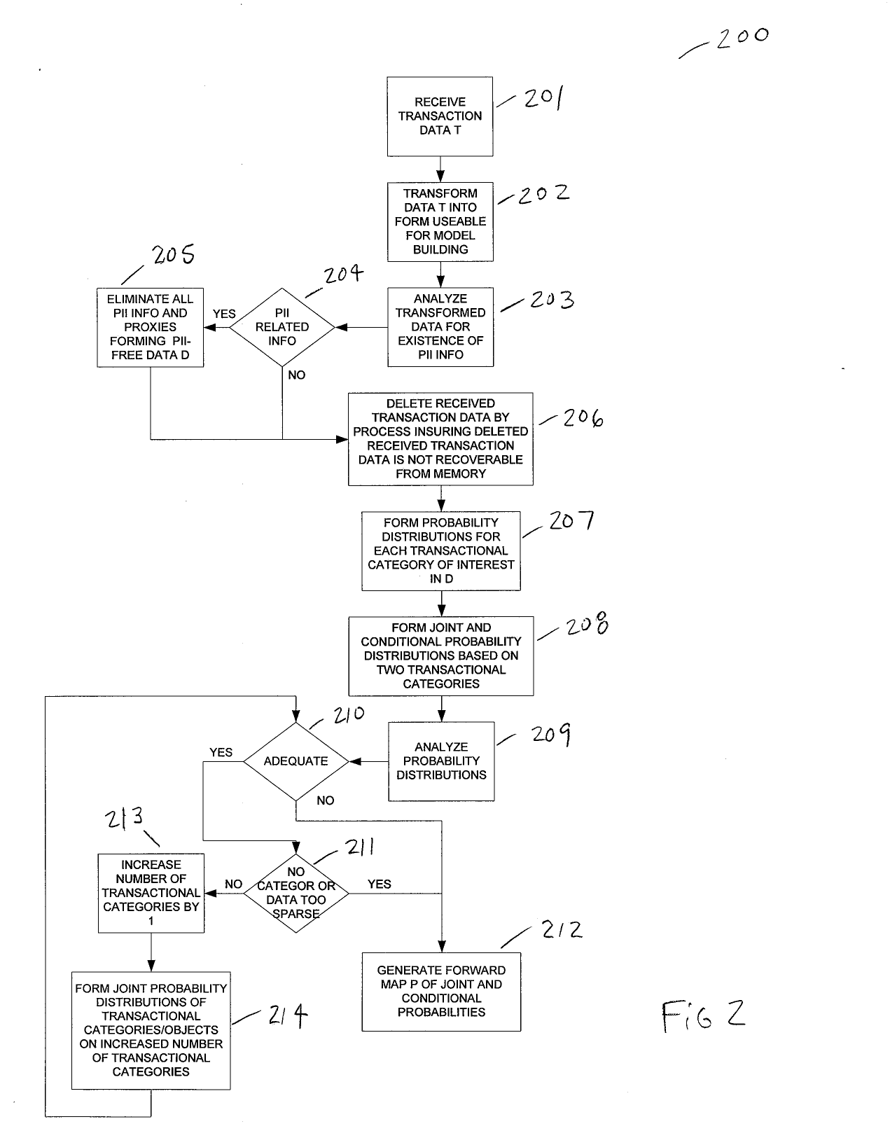

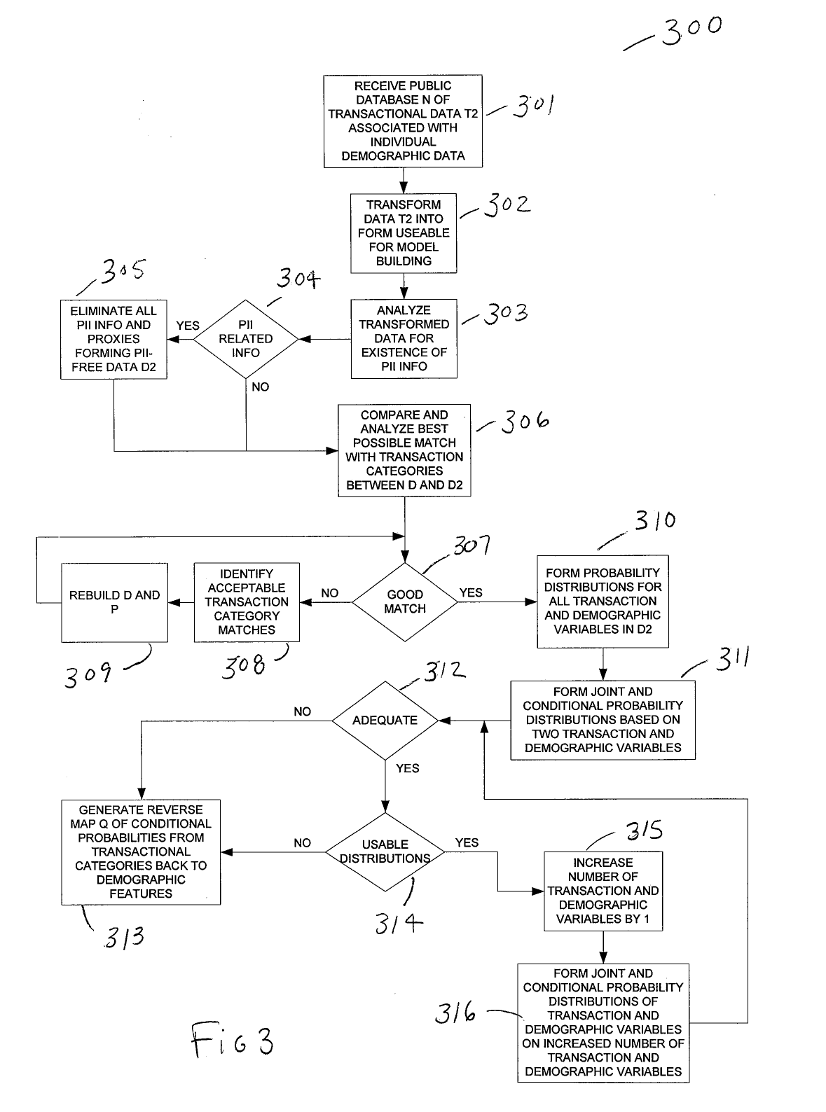

FIG. 1 shows a diagram of a system for a correlation engine (ACE) according to an exemplary embodiment of the present invention. In this exemplary embodiment, a system 100 may include correlation engine 106, a private transactional data server 105, and a modeling/public data server 107. The correlation engine 106 may be a server and may include a network interface 109, an encoder/decoder 110, an input device 111, a processor 112, a display 113 and a memory 114. The transaction data server may include a network interface 121, an encoder/decoder 120, an input device 117, a processor 118, a display 119, a database 115 and a memory 116. Similarly, the modeling/public data server 107 may include a network interface 128, an encoder/decoder 127, an input device 124, a processor 125, a display 126, a database 122 and a memory 123.

The correlation engine 106, the private transactional data server 105, and the modeling/public data server 107 may be interconnected via a network 108. The network 108 may be an intranet, the Internet, a local area network (LAN), a wide area network (WAN) or any other type of network. There may be four dataflow channels, each carrying a particular kind of information into and out of the ACE server 106. These may include a channel A 101, a channel B 102, a channel C 103 and a channel D 104. The channel A 101 may communicate transactional data from the private transactional data server 105 to the ACE server 106. The private transactional data server 105 may generally have transactional or historical data that in association with the PII of patients or customers or account holders may not be used in a model generation process. This channel A 101 may therefore be filtered to remove all PII, even at the expense of transactional detail. This filtering process may include but is not limited to: removal of account numbers, removal of demographic information, or removal of specific transaction details that might permit the individual associated with the record to be inferred by a nefarious third party (e.g., in the event that the ACE server 106 physically resides outside of protected data boundaries of a transaction DB data center). In this latter case this channel A 101 may be encrypted with strong encryption to protect it in transit. The ACE server 106 may physically reside in a secure data center.

The channel B 102 may communicate public information from a (possibly third party) modeling/public data server 107. The modeling server 107 may contain and provide demographic information in association with transaction data. However, there is no known direct overlap with the individuals represented in the transaction data. This may be information that is either not PII restricted because of its source (e.g., U.S. census data, data obtained from firms that enhance public data drawn with non-PII protected information drawn from many private sources, etc.). It may also be transactional data that belongs to a third party organization (e.g., a client building a “traditional” predictive model on the basis of their own data, a firm conducting a drug trial, etc.) that is permissioned for this purpose. If the ACE server 106 is not co-located with a third party modeling server 107 in a secure data center, again it may be desired that the channel B 102 be encrypted with strong encryption to protect it in transit. The ACE server 106 may physically reside in a secure data center.

The channel C 103 may communicate transmission of an enhanced forward map and/or a unified map back to the modeling server(s) 107. These maps may then be used as Bayesian prior information in a model generation process. The forward map may consist of any of several forms. For example, it may be a multidimensional correlation matrix (usually of dimension considerably higher than one), it may be a neural network model built on the demographic space represented in public data that maps, e.g., demographic variables to entire transactional patterns of known value to the model generation process, it may be a simpler (e.g., logistic or tree) model that similarly maps public variables into transactional patterns of value to the model generation process. This channel may be secured either by co-location in a secure environment or via strong encryption, although there is no PII in this product and there is no legal risk or possibility of violation of individual privacy inherent to the forward map.

The channel D 104 may communicate transmission of the enhanced inverse map and/or unified map back to the transaction servers 105. On the transaction server 105 this inverse map can be processed to “dress” any given transactional record with a “best guess” as to its originating coarse-grained demographics without the use of PII. Alternatively, the inverse map itself may be a valuable product that can be resold to organizations that possess similarly organized but PII-free collections of transaction data who wish to gain insight into the possible demographics associated with particular transaction patterns that can be connected with a single individual or household (by, for example, account number or other anonymous identifier) but where the merchant or transaction owner has no direct means of determining the identity associated with the records and hence performing a direct demographic match. This information may be used in a manner similar to that communicated via channel C to enhance model generation processes as Bayesian priors or for more strategic (e.g., business or healthcare) related purposes.

According to embodiments of the present invention, the inverse map contains no PII and cannot be used to identify any individual in or outside of the original transactional database 105 used to build the forward map or inverse map. It may be desired that channel D be co-located or secured by strong encryption. A general description of the process of forming the forward and reverse maps from the data sources and the output results of those processes follows in the next sections.

According to embodiments of the present invention, a correlation engine server may be configured to execute one or more processes that generate a forward map. The correlation engine server may receive data from a transaction data server (TDS) (defined to be a database containing PII-restricted data, whether or not it is transactional in nature) and transform it into a form that retains the maximum amount of statistically useful information but that contains no PII. The correlation engine server (ACE) may be configured to:

(i) receive transaction data T from the TDS, possibly on an encrypted channel, and if necessary, decrypt it. See channel A in FIG. 1 above;

(ii) utilize the accompanying data dictionary to transform the data into a form suitable for model generation. This may involves many actions—determining the types of variables (ordinal, enumerative, continuous) and their ranges and converting the data into a suitable vector of typed, ranged, numerical quantities. It may also require aggregation of underrepresented quantities and/or functional transforms of individual fields or field vectors. The particular actions utilized may be common to many modeling schema.

(iii) if the data still contains PII (depending on whether or not the owner of the private data has eliminated it before sending the data to the ACE), identify it, and perform a analysis of the data looking for PII proxies—data entries in the transformed data that have a strong correlation with specific PII that could conceivably be used to infer the PII from the data.

(iv) eliminate all PII and all proxies to form a PII-free transaction dataset D that is in a form suitable for creating the forward map.

(v) delete the original dataset T, taking care to actually scrub memory and disk so that it is not recoverable. The correlation engine server now has PII-free in its D data content before beginning to actually build the forward map.

(vi) form the inferred probability distributions for each transactional quantity of interest (or aggregated cluster of such quantities) in D. This may be as simple as counting (or binning) and dividing to form probabilities and estimated variances, or may involve an actual Bayesian calculation. These numbers can be interpreted as: “the observed probability of individuals occurring within the given transactional category” in the original database T. None of these probabilities reveal PII. The data from which they were built contained no PII, and the forming of the probabilities strictly aggregates the data so that no trace of individual records remains. The output may be a list of numbers representing the distribution of membership probabilities in all suitably binned transactional fields or categories (which may or may not be independent).

(vii) form the pair wise joint and conditional probability distributions. In the simplest case, count the number of records that are members of two transactional categories and normalize to form a joint probability over the entire database, or normalize by the number of members of one of the two sets to form a conditional probability. These numbers can be further renormalized by the probabilities formed in the previous step to form “likelihoods” in anticipation of using Bayes' Theorem. More complex cases (involving fields for which Bayesian priors exist) may require a more involved methodology.

(viii) based on an analysis of the probabilities resulting from the previous level of joint probability distribution, form the joint probability distribution of transactional categories or objects taken three, four, or more at a time. The depth and granularity of the lowest level will be determined by the requirement of maintaining sufficient representatives in each category for the joint probabilities thus formed to be reasonably accurate, and where the apparent utility and strength of the correlations revealed in the course of computation are relevant to end use targets.

The forward product (map) is the complete set of joint and conditional probabilities P (and any associated variances) derived from the PII-free transactional data D. As noted, D itself has no PII as it has been removed either by the TDS or by the ACE server at the very beginning of the computation (along with any hidden proxy variables that might inadvertently reveal it upon analysis). The process of forming the vectors and matrices above further erases all the details of individual transactions or records. The forward product is thus PII-free and thus cannot violate and of privacy restrictions or agreements associated with the original data. It cannot be used to identify—directly or indirectly by any brute force attack any single individual whose data may or many not have been used in the construction of the product. The resulting product P can then be sent on to an external (ACE or third party) modeling server and used in the construction of predictive models, or it can be retained on the ACE server and used to build the reverse product, or both. See channel C in FIG. 1 above.

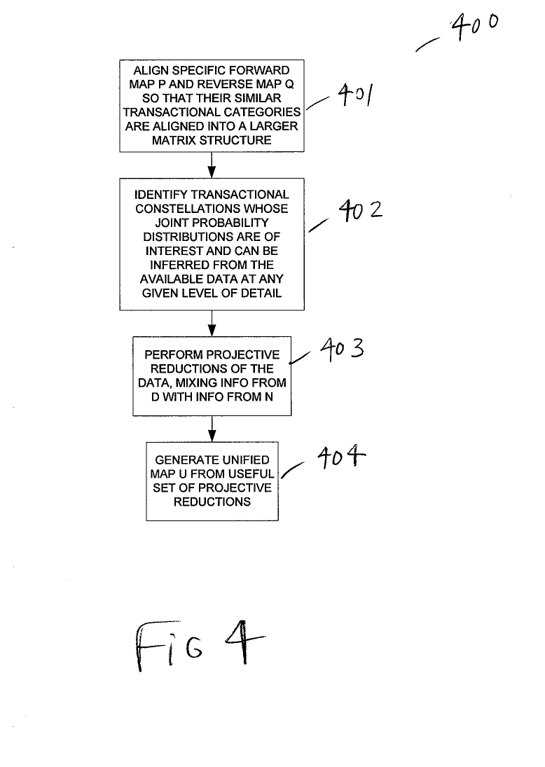

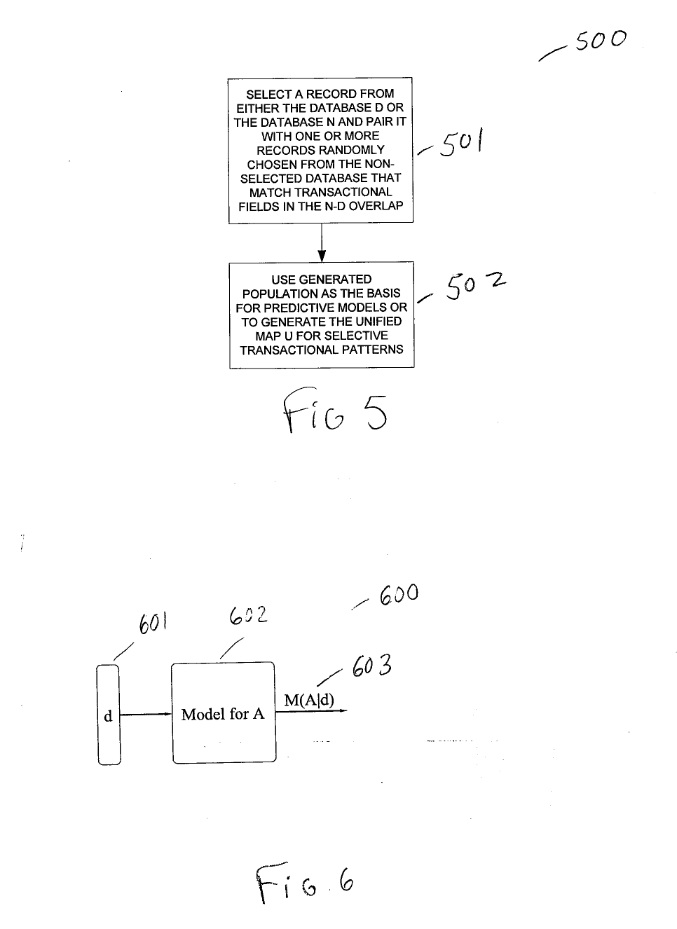

FIG. 2 shows a flowchart of a process for creating a forward map according to an exemplary embodiment of the present invention. In the process 200, in block 201 transaction data t may be received. In block 202 data t may be transformed into a form useable for model building. In block 203 the transformed data may be analyzed for the existence of PII information. In block 204 it may be determined whether any PII related information exists in the transformed data and if so, then in block 205 all PII information and proxies is eliminated forming PII-free data D. Then in block 206 the received transaction data may be deleted by a process insuring that the deleted received transaction data is not recoverable from memory.

If no PII related information exists in the transformed data, then in block 206 the received transaction data may be deleted by a process insuring that the deleted received transaction data is not recoverable from memory. In block 207 probability distributions may be formed for each transactional category of interest in D. In block 208 joint and conditional probability distributions may be formed based on two transactional categories. In block 209 the probability distributions may be analyzed. In block 210 it may be determined whether the probability distributions are adequate and if not, in block 212 a forward map P of joint and conditional probabilities may be generated. If the probability distributions are adequate then in block 211 it may be determined whether there are no more categories or whether the data is too sparse to yield valid inferences and if so, in block 212 a forward map P of joint and conditional probabilities may be generated. If there are more categories and the data is not too sparse to yield valid inferences, then in block 213 the number of transactional categories may be increased by 1 and in block 214 joint probability distributions of transactional categories/objects may be formed on the increased number of transactional categories and the process return to block 210 where it may be determined whether the probability distributions are adequate.

According to embodiments of the present invention, a correlation engine server may be configured to execute one or more processes that generate a reverse map. The correlation engine server may take the product P (the forward map) and combines it with a non-private mix of transactional and demographic data from any of several possible sources that has transactional categorical overlap with the categories whose joint and conditional probabilities are well and accurately known over a similar base population to form a reverse projection of category membership onto fields represented in the non-private data. The correlation engine server (ACE) may be configured to:

(i) import a non-private database N that contains transactional data in association with individual demographic) data. (see channel B above).

(ii) subject N to a similar process of analysis and transformation to the one used in the generation of D from T above, with the goal being to make the transactional categorical features represented therein the best possible match to those in D.

(iii) perform and analyze this “best possible” match with the transactional categories represented in D and converted into the forward map P in the previous process. If there is no good match (but the original dataset T does support the construction of categories that are an acceptable match) then rebuild D and P to accomplish this. Iterate as necessary until a good match is obtained.

(iv) form the basic probability distributions (counts) for all the transactional and demographic variables, independently. The end product of this analysis is, for example, the probabilities that a randomly selected member of the set N is male, is female, is unknown, the probability that a randomly selected member belongs to transactional category or bin A matching a similar bin in D and P.

(v) form the various orders of joint or conditional probabilities as determined from the data in N. This will produce (for example) the probability that an individual randomly selected from N is a male who belongs to transactional category A, the probability that a male randomly selected from N is also in transactional category A, the probability that a member of transactional category A is also a male. As before, extend this analysis two, three, four, or more items at a time as supported by the end purpose of the product and the data itself.

(vi) The conditional probabilities from transactional categories back to demographic features constitute the partial reverse map Q and are a product produced by the correlation engine server (i.e., ACE). The map Q can, for example, be returned to the original TDS and applied to PII-free transactional records that are good matches to determine the probability that the unknown originator of that transactional record is male, is female, or has an age in some fixed range. See channel D above. Alternatively it can be applied to the retained PII-free database D to augment it with inferred demographics for further modeling utilization.

FIG. 3 shows a flowchart of a process for creating a reverse map according to an exemplary embodiment of the present invention. In the process 300, in block 301 a public database n of transactional data T2 associated with individual demographic data may be received. In block 302 the data T2 may be transformed into a form useable for model building. In block 303 the transformed data may be analyzed for the existence of PII information. In block 304 it may be determined whether PII related information exists in the transformed data and if so, then in block 305 all PII information and proxies is eliminated from the transformed data forming PII-free data D2. Then, in block 306 a best possible match with transaction categories between D and D2 may be compared and analyzed. If no PII related information exists in the transformed data then in block 306 a best possible match with transaction categories between D and D2 may be compared and analyzed.

In block 307 it may be determined whether a good match exists. If a good match does not exist then in block 308 acceptable transaction category matches may be identified, in block 309 D and P may be rebuilt and the process return to block 307 where it may be determined whether a good match exists. If a good match does exist then in block 310 probability distributions may be formed for all transaction and demographic variables in D2 and in block 311 joint and conditional probability distributions may be formed based on two transaction and demographic variables. Then, in block 312 it may be determined whether the joint and conditional probability distributions are adequate and if not, then in block 313 a reverse map Q may be generated of conditional probabilities from transactional categories back to demographic features. If the joint and conditional probability distributions are adequate then in block 314 it may be determined whether there are usable, statistically significant joint and conditional probability distributions and if not, then in block 313 a reverse map Q may be generated of conditional probabilities from transactional categories back to demographic features. If there are usable, statistically significant joint and conditional probability distributions then in block 315 the number of transaction and demographic variables may be increased by 1 and in block 316 joint probability and conditional distributions of transaction and demographic variables may be formed on the increased number of transaction and demographic variables and the process return to block 312 where it may be determined whether the joint and conditional probability distributions are adequate.

With both the forward map P and the reverse map Q generated and accessible by the ACE server, several derived products and services are enabled. One of these is the unified map U that is the set of all Bayesian reductions of the two maps P and Q. For example, suppose that a particularly high degree of correlation is observed between a “constellation” of membership in two particular transactional categories and (say) being female in the reverse map Q. Suppose further that this constellation is strongly correlated with simultaneous membership in another constellation of transactional categories in the forward map P. Then there are several conditional inferences that can be made, such as membership in the second transaction category is likely conditional on being female even though the particular transactional category in question is not represented in the non-private database N.

An heuristic example of the underlying reasoning in an artificially extreme case might be: “All purchasers at J. Jill are female. All purchasers at J. Jill are also purchasers at Ann Taylor. The probability that a randomly selected female shops at J. Jill can be computed from transactions in N, but shopping at Ann Taylor is not in N. Nevertheless, the probability that a randomly selected female shops at J. Jill is a good estimate for the probability that an otherwise similar randomly selected female shops at Ann Taylor.”

However, the point of the statistical reduction process that creates U is that it is not heuristic, it is quantitative and objective and can reveal more subtle correlations that would be very difficult to guess on heuristic grounds. The correlation engine server (ACE) may be configured to:

(i) align specific P (forward) and Q (reverse) maps so that their similar transactional categories are aligned, into a larger matrix structure that can represent the non-shared components in block-diagonal sub-matrices with no direct overlap.

(ii) identify particular transactional constellations whose joint probability distributions are of interest and (by iterating the next two steps) can be legitimately inferred from the available data at any given level of detail (dimensionality of the results).

(iii) perform projective reductions of the data, mixing the information derived from D with that derived from N via their overlap terms (e.g., using Bayes' theorem). This process can yield inferences that determine the probability of certain transactional behavior not represented in N given data not represented in T, connected by terms that are strongly coupled in N at least one of which is also strongly coupled to a member of a set of strongly coupled terms in T.

FIG. 4 shows a flowchart of a process for creating a unified map according to an exemplary embodiment of the present invention. In the process 400, in block 401 a specific forward map P and reverse map Q may be aligned so that their similar transactional categories are aligned into a larger matrix structure. In block 402 transactional constellations whose joint probability distributions are of interest and can be inferred from the available data at any given level of detail may be identified. In block 403 perform projective reductions of the data may be performed, mixing information from D with information from N. In block 404 a unified map U may be generated from the useful set of projective reductions.

A useful set of these “forward and reverse” reductions constitutes the unified map U. According to another embodiment of the present invention, a secondary process for generating the unified map is to directly join a statistical extrapolation of the data from the N and D sets, using re-sampling. In this embodiment, the correlation engine server (ACE) may be configured to:

(i) select a record from either database (usually the smaller, usually N), and pair it with one or more records that are randomly selected from the records in D that match (within a given tolerance) in the transactional fields in the N-D overlap.

(ii) use the population thus generated as the basis of predictive models or to generate the unified map for selective “interesting” transactional patterns as before.

FIG. 5 shows a flowchart of a process for creating a unified map according to another exemplary embodiment of the present invention. In the process 500, in block 501 a record may be selected from either the database D or the database N and paired with one or more records randomly chosen from the non-selected database that match transactional fields in the N-D overlap. In block 502 the generated population may be used as the basis for predictive models or to generate the unified map U for selective transactional patterns. An advantage of the embodiment shown in FIG. 5 is that it permits a wide range of modeling techniques to be used with the simulated, unified PII-free database. A disadvantage may be that the simulated population may contain “artifacts” in the form of false inferences that can be drawn where populations are small, but these limitations can be compensated for in the model generation process used.

To help illustrate embodiments of the present invention several example databases will be considered. For an example of a private database that includes PII, consider credit card expenditures at a chain of combined gas station/quick marts that sell alcoholic beverages (AB) and non-alcoholic beverages (NAB) such as coffee, soda, and milk in addition to food and sundry items. Purchases made with the branded chain card permit itemized expenditures per month to be tallied, per cardholder. Several views of this database are available; one to the merchant and/or credit card company, which has nothing but card number and monthly totals in these five transactional categories (but where the card number and individual transactional records are nevertheless PII) and another to the card issuer, typically a bank, that has the relationship with the customer and has the customer's social security number, address, age, and gender in addition to all transactional records associated with the card (which is a general purpose credit card and may be used at locations other than the gas station/quick mart).

Let us consider the view available only to the gas station:

TABLE 1
Private Database

| Card Number | Gas | AB | NAB | Food | Sundries |
|---|---|---|---|---|---|
| 4321987654320001 | 127.00 | 135.77 | 0.00 | 41.23 | 17.85 |
| 4321987654320002 | 73.00 | 0.00 | 0.00 | 12.42 | 27.53 |
| 4321987654320003 | 143.12 | 12.37 | 18.41 | 5.37 | 8.44 |
| 4321987654320004 | 30.00 | 9.87 | 48.52 | 166.76 | 63.98 |
| 4321987654320005 | 57.00 | 35.54 | 22.12 | 9.93 | 0.00 |
| . | . | . | . | . | . |
| . | . | . | . | . | . |
| . | . | . | . | . | . |

In Table 1 above, PII is clearly visible in the form of the card number. This data is immediately stripped off by the Arcametrics engine, resulting in the following table:

TABLE 2
PII-Stripped Private Database

| Gas | AB | NAB | Food | Sundries |
|---|---|---|---|---|
| 127.00 | 135.77 | 0.00 | 41.23 | 17.85 |
| 73.00 | 0.00 | 0.00 | 12.42 | 27.53 |
| 143.12 | 12.37 | 18.41 | 5.37 | 8.44 |
| 30.00 | 9.87 | 48.52 | 166.76 | 63.98 |
| 57.00 | 35.54 | 22.12 | 9.93 | 0.00 |

It is clear that this simple step already anonymizes the database as far as most privacy rules are concerned. However, the database still contains records of the transactions of individuals and the card customers may not wish their personal transaction records to be released or resold to third parties even without any of their personal information attached. The Arcametrics Correlation Engine therefore forms a systematic reduction of this database to a set of cumulative/aggregated, binned, matrices. For example, the (extremely coarse grained) distribution of gasoline expenditures is found to be:

TABLE 3
Distribution of Gas Purchase Totals in Private Database

| Gas | Count | P(Gas) |
|---|---|---|
| 0.00-49.99 | 237134 | 0.123 |
| 50.00-99.99 | 383009 | 0.201 |
| 100.00-149.99 | 578128 | 0.303 |
| 150.00-199.99 | 413790 | 0.217 |
| 200.00-249.99 | 198651 | 0.104 |
| 250.00+ | 97244 | 0.051 |

There are 1907956 individuals in the database, and from the count we can easily deduce the probability of an individual in this database, selected at random, having a gasoline expenditure in any of the given ranges. Similar binned sums and probabilities are formed for the other transactional categories in suitably granulated ranges. Note well that the open publication or resale of this aggregated information in no way violates any of the privacy concerns of the individuals in the database. If a quick mart publishes a statistic that 12.3% of its customers are spending between $0 and $50.00 on gasoline each month, it is absolutely impossible to deduce from this information that e.g. Caroline Chang of 17 Elm street with card number 4321987654320004, social security number 000-00-0004, was a 71 year old female who purchased $30.00 worth of gasoline and was a small part of the information aggregated in this statistic.

Even this simply summed and averaged information can be of value to e.g. the board of directors of the company or the card issuer, as it gives them a statistical profile of their customer base and hence many opportunities to maximize profits based on what they learn from the transaction statistics. However, the Arcametrics Correlation Engine goes on to analyze the data for more complex statistical patterns. For example, it counts the number of people who are in each gasoline purchase category who also have (extremely coarse grained for purposes of demonstration) ranged expenditures in the alcoholic beverage (AB) category:

TABLE 4
Joint Distribution of Expenditure on
Alcoholic Beverages and Gasoline in Private Database

| Gas Range | AB 0.00-24.99 | AB 25.00-49.99 | AB 50.00+ |
|---|---|---|---|
| 0.00-49.99 | 145170 | 72573 | 19391 |
| 50.00-99.99 | 198564 | 143007 | 41438 |
| 100.00-149.99 | 215599 | 202193 | 160336 |
| 150.00-199.99 | 132074 | 158660 | 123056 |
| 200.00-249.99 | 13631 | 24986 | 160034 |
| 250+ | 3913 | 11187 | 82144 |

As before, these counts can be normalized by the total and turned into a joint probability matrix:

TABLE 5
Joint Probability Distribution of Expenditure
on Alcoholic Beverages and Gasoline in Private Database

| Gas Range | AB 0.00-24.99 | AB 25.00-49.99 | AB 50.00+ |
|---|---|---|---|
| 0.00-49.99 | 0.076 | 0.038 | 0.010 |
| 50.00-99.99 | 0.104 | 0.075 | 0.022 |
| 100.00-149.99 | 0.113 | 0.106 | 0.084 |
| 150.00-199.99 | 0.069 | 0.083 | 0.064 |
| 200.00-249.99 | 0.007 | 0.013 | 0.084 |
| 250+ | 0.002 | 0.006 | 0.043 |

There are many features in this joint probability distribution that are of immediate interest. For example, if we use Bayes theorem to renormalize by range we can compute the probability distribution for an individual purchasing over $50.00 worth of alcoholic beverages in a month given that they spend over $250 a month for gas. This becomes the row:

TABLE 6
Reweighted probability of alcoholic beverages purchase
for specific range of gasoline purchase in private database

| Gas Range | AB 0.00-24.99 | AB 25.00-49.99 | AB 50.00+ |
|---|---|---|---|
| 250+ | 0.04 | 0.12 | 0.84 |

We see that it is twenty one time more likely that a person who purchases over $250 worth of gas a month at the quick marts in question will also purchase over $50 worth of beer or wine. This PII-free information is of tremendous value to marketing and management. If we similarly use Bayes theorem to renormalize other rows and/or columns and thereby form conditional probabilities we can learn (for example) that 61% of the customers who spend less than $50 per month on gasoline also spend less than $25 on alcoholic beverages and that only 8% of them spend over $50.

The Arcametric Correlation Engine forms all of these joint and conditional probability matrices that it can while preserving some measure of statistical reliability in the result, forming the renormalized counts for purchase of gas in a given range, purchase of alcoholic beverages in a certain range, and purchase of sundries in a certain range and looking for non-flat regions where joint categories stand out as highly probable or improbable behaviors. The union of all of these vectors and multidimensional matrices constitutes the forward map.

This now PII-free information is obviously already of direct value, although it cannot in and of itself be used to direct a marketing campaign without access to either the demographic information on cardholders (belonging to the issuer) or to permissioned data with overlapping transactional categories and associated demographics. Let us see how this additional information can be connected back to the joint and conditional probability distributions derived from the private database by considering a second, non-private database.

In our example, this one belongs to the same company but it is from a “frequent shopper program” and hence is permissioned. It is a much smaller database because most customers did not bother joining the program and because many of those customers pay with cash or check cards—it isn't exclusively for cardholders. However, it does contain a statistically significant number of members and connects their transactional behavior in the same categories with demographic information on the customers in a permissioned way.

TABLE 7
Public (Permissioned) Database

| Name | Address | Age | Gender | Gas | AB | NAB | Food | Sundries |
|---|---|---|---|---|---|---|---|---|
| Harry | 1 Main | 22 | M | 142.94 | 82.38 | 24.67 | 30.19 | 0.00 |
| Buck | Street | | | | | | | |
| George | 2 Sixth | 36 | M | 248.61 | 16.59 | 3.76 | 0.00 | 8.47 |
| Stevens | Street | | | | | | | |
| Anne | 2 Sixth | 35 | F | 93.16 | 0.00 | 22.99 | 15.32 | 21.78 |
| Stevens | Street | | | | | | | |
| Sarah | 4 River | 71 | F | 46.64 | 0.00 | 53.92 | 131.76 | 48.20 |
| Williams | Place | | | | | | | |
| Sally | 5 Eagle | 25 | F | 57.00 | 35.54 | 22.12 | 9.93 | 0.00 |
| May | Avenue | | | | | | | |

We note several things of interest in this example database. The fifth entry precisely matches an entry in the credit card database. From this an individual who possessed both databases could reasonably infer that the owner of card 4321987654320005 was Sally May, who lives at 5 Eagle Avenue and is a 25 year old female who drinks a moderate amount of alcoholic beverages every month purchased at quick marts. This is an example of how access to PII data can clearly violate the privacy of individuals as Sally May could easily be targeted for e.g. identity theft by an unscrupulous individual in possession of the joined database records following a very probable match. By stripping the private database of PII and providing it only in aggregate form, we prevent precisely this sort of abuse—an individual who possesses the joint and conditional probability distribution derived from the private database can infer nothing on a personal level about the individuals whose transactional behavior is summarized therein.

Also, since there is some population overlap between the two databases, we can reasonably expect the joint behavioral patterns that are represented in them to be similar. The Arcametrics Correlation Engine therefore performs the same general process on the second database—transforming it ultimately into a set of tables of probabilities, joint probabilities, and conditional probabilities on membership in a suitably (similarly) granulated set of transactional categories, some of which overlap with those of the private database. We will ignore most of these possibilities to focus on only one combination: Gender, Gas, and Alcoholic Beverage:

TABLE 8
Joint probability distribution of binned expenditure on
alcoholic beverages and gasoline in non-private database for Males

| Gas Range | AB 0.00-24.99 | AB 25.00-49.99 | AB 50.00+ |
|---|---|---|---|
| 0.00-49.99 | 0.031 | 0.015 | 0.004 |
| 50.00-99.99 | 0.071 | 0.041 | 0.010 |
| 100.00-149.99 | 0.104 | 0.098 | 0.080 |
| 150.00-199.99 | 0.060 | 0.066 | 0.059 |
| 200.00-249.99 | 0.005 | 0.009 | 0.079 |
| 250+ | 0.002 | 0.005 | 0.040 |

TABLE 9
Joint probability distribution of binned expenditure on
alcoholic beverages and gasoline in non-private database for Females

| Gas Range | AB 0.00-24.99 | AB 25.00-49.99 | AB 50.00+ |
|---|---|---|---|
| 0.00-49.99 | 0.035 | 0.023 | 0.006 |
| 50.00-99.99 | 0.031 | 0.024 | 0.012 |
| 100.00-149.99 | 0.009 | 0.008 | 0.004 |
| 150.00-199.99 | 0.009 | 0.017 | 0.005 |
| 200.00-249.99 | 0.002 | 0.004 | 0.005 |
| 250+ | 0.000 | 0.001 | 0.003 |

Table 8 and Table 9 (which represent sheets of a three-dimensional 6×4×2 matrix) are examples of the reverse map generated by the Arcametrics Correlation Engine. In this somewhat artificial example, the matchup between some of the fields in the public database and the private database is perfect, but the ACE will use inference to match up less perfectly comparable fields to yield positive yield in reverse projective prediction capabilities.

One use described above for this non-private database is for the two maps (forward and reverse) to be united to enable inferences to be made concerning the private database, forming the unified map that contains all of the available information in the two databases that can be justified on the basis of Bayesian statistical inference.

We see from the non-private data that frequent shoppers who spend over $250 a month at the quick mart and are male represent a total of 0.47% of the frequent shopper population, while frequent shoppers who spend over $250 a month at the quick mart and are female represent a total of only 0.04%. It is thus almost eleven to one odds that any individual in the private database who spends over $250 a month at the quick mart is male, odds that increase to better than thirteen to one if the individual in question spends over $50/month on alcoholic beverages! We would be very safe in “enhancing” the records of individuals in either database with specific constellations of values derived from the joint and conditional probability distributions in the other. For example, we can enhance the private database with e.g. the weighted probability (from all such patterns in the public database) that the individual is male or female, the probability that they are in any given age range, and other inferable demographics that are strongly correlated with patterns in the permissioned data. The union of all such statistically justified inferences used to “decorate” the individual records of both databases forms the unified map.

The unified map has obvious and immediate value to the credit card company and the merchant in this example (who get an extended, if approximate, picture of the base of credit card holders in the private database even though they do not possess any definite demographic information on these particular cardholders). Note well the efficiency of applying a numerical map to decorate the PII-free records with approximate demographics in any event compared to e.g. attempting to join those records with some sort of demographic database, a process requiring many steps to clean the data, renormalize variables, deal with the inevitable holes where no match is found. The Arcametrics Correlation Engine has to perform many of those steps as well to form the unified map, but this becomes a significant value added proposition for the users of those maps as pure compressed information.

The unified map has still greater value for the card issuer, who does have the demographic and contact information for each cardholder and can use this information to legitimately target the cardholders for special offers from the merchant with a much higher chance of the offers being accepted than if the targets and offers were both randomly selected (assuming, of course, that there is a positive correlation between the projected demographic attributes and propensities to respond to the offers). It also has one final valuable purpose to the merchant—the forward map and unified map can powerfully enhance any direct (targeted) marketing campaign undertaken by the merchant.

It is therefore worth illustrating the utility of the joint and conditional probability distributions in the forward map derived from the private data in this context. Suppose that the quick mart company wishes to run a campaign to attract new customers for things other than gas in the geographic vicinity of their stores by means of directly mailing them a special coupon for reduced-price beer if purchased with a fill-up. We will further imagine that the only information they have at their disposal is the private credit card database illustrated above, which has no demographic variables and which cannot be legally matched to any specific records that do have demographic variables associated with the individual transactional records therein.

Instead of the being fortunate enough to possess a “perfectly matched” frequent shopper database, we will suppose that the quick mart purchases a commercial demographic database which associates customer demographic information (including names and addresses) in their targeted area and which contain fields for each customer derived from certain transactional behavior, tallying e.g. the number of cars the individual has publicly registered with their state of residence and their probable monthly expenditure on fuel (either directly or as a derived quantity).

The usual method for building a predictive model would be to target individuals in the regions of interest either randomly or heuristically and track the results of e.g. a direct mailing. Using these results, predictive models are built that can be used to improve the yield per piece mailed.

In our example the merchant instead uses correlation matrices derived from the private database. From these matrices, they note that individuals with very high monthly gasoline expenditures are far more likely than average to spend over $50/month on alcoholic beverages at the quick mart. They can therefore create a very simple model on the demographic database that selects customers in the appropriate geographical regions that are likely to spend over $200/month for gasoline and make them the particular offer of e.g. two for the price of one cases of beer with a fill-up, and have a very reasonable expectation that the mailing will significantly beat the return on investment of a purely random mailing or universal mailing in the target areas.

This process can be further enhanced by the use of the full unified database in our original example—both the correlations discovered in the private database and (if available) the partially demographic information in the frequent shopper database, which contains more fields that overlap with the commercial demographic database (such as gender). Targeting single males who purchase a lot of gasoline for the beer offer should improve yields even more. Building an actual multivariate predictive model based on shared fields in the frequent shopper database, enhanced with the private correlation matrices, and applying it on the commercial demographic database should improve yields even more. Finally, using any of these heuristic or semi-heuristic models as starter models and conducting a full campaign over time that uses returns from a mix of randomly selected and heuristically targets plus the correlation matrices to build fully demographic predictive models should (over time) do best of all, the best that can possibly be done.

The various forward, reverse, and unified maps created by the Arcametrics Correlation Engine permit a merchant, the credit card company, or the issuer to take full advantage of all legally and ethically available information (publicly or privately derived) for any particular purpose.

FIG. 6 shows a model for a transactional target according to an exemplary embodiment of the present invention. The model 600 shows PII-free data d 601 being input into a model for a class A 602 where the model 602 estimates an ordinal model score 603 for membership in class A. According to embodiments of the present invention, a correlation engine server can do more than generate joint probability distributions and correlation matrices. It may also be configured to use the maps defined above as Bayesian priors in the construction of actual predictive models. To help illustrate embodiments of the present invention, exemplary information regarding what a predictive model is and how it functions will be presented. A predictive model is a map between a vector of data descriptors drawn from some population of data vectors and an outcome (which may be itself be a vector of discrete or continuous numbers corresponding to some categorical sorting of the data vectors in the population). The model can attempt to match the empirical pattern, match in an extrapolative way the actual probability distribution of the outcome (membership in some class, for example) given the data of each member of the population, or simply sort the population into likelihood of class membership given the data, where the final (non-normalized) possibility is the simplest to implement and in many cases suffices. For example, a classification model 602 might estimate M(A|data) 603, an ordinal model score for membership in class A given a vector of data corresponding to a member of the population from which the model is built and to which it will be applied. M need not be an actual probability, but can instead be a monotonic function of the probability, so that individuals with higher model scores are more likely to be in A than individuals with lower ones.

Using such a model, a population of individuals may be sort out, given their data, according to their probability of being in class A (which might be “accepters of a tendered offer” in business or “individuals who have cancer” in medicine), and, if certain Bayesian priors are available (such as the expected prevalence of membership in the population) M may be corrected so that it closely approximates P(A|data), the actual probability of membership. For illustrative purposes, predictive modeling as discussed in embodiments according to the present invention refer to statistical modeling however, embodiments of the present invention are not limited to statistical modeling.

Several examples are presented following to help illustrate how outputs, correlations, etc. generated by a correlation engine server according to embodiments of the present invention can be used to produce complex models that outperform models built without these outputs, correlations, etc. generated by the correlation engine server, subject only to the validity of the statistical assumptions (such as congruence of the populations in the disjoint databases—they should either be the same population or selected to be as similar as possible, although the processes described below will often correct for dissimilarity over the course of application as they are adaptive methodologies).

The following non-exhaustive list of components of a model generation process according to embodiments of the present invention are defined, indicating where the data or structures involved comes from in the process:

M or P: Predictive models as described above. A successful model M assigns to each member of a population a number that monotone increases with probability of membership in some target category or categories, given the entirety of the information available to build the model.

A, B, C . . . : Various target categories in predictive models of M or P, e.g. M(A| . . . ), M(B| . . . ), P(A| . . . ) etc. In this the ellipsis ( . . . ) can stand for any combination of:

˜d: A vector of publicly available “demographic” data associated with the population common to the public and private databases.

˜t: A vector of publicly available “transactional” data associated with the problem. ˜tp is the part of the vector that is derivable from the PII-private database. ˜tn is the part of the vector that is derivable from the non-PII-private database or obtainable through the process that creates the model(s). These two subvectors will in general overlap, with shared transactional categories.

˜p: A vector of “other” information or data that might be used to build the model, in particular Bayesian priors in the form of: heuristics derived outside of the model generation process altogether; secondary models; correlation matrices of the kinds described above that are the products of the ACE.

FIG. 7 shows a diagram of a model for a two stage correlated model according to an exemplary embodiment of the present invention. The two stage correlated model 700 may include a model 701 for a product A that receives PII-free data d 702, a corrector model 703 for a product B that receives data d 702, where the outputs from the model 701 for a product A and the corrector model 703 for a product B feed into a posterior model 707 for the product B. This model may be generated by a correlation engine server according to embodiments of the present invention and illustrates an example of the constructive use of PII-derived knowledge in the generation of improved models. To be concrete, this example will describe an application where A, B, C . . . describe a targeted marketing project. A company wishes to sell products A, B and C (and quite possibly more) to individuals in some general population. Without any marketing at all, there is a certain probability Pr(A) that randomly selected members of this population will purchase e.g. A in any given month. If a randomly selected (untargeted) person receives a direct communication from the company making them a (possibly incentivized) offer, that probability will typically increase to Po(A) (where neither number may be known at the beginning of the campaign), but where it is expected that Po(A)>Pr(A).

The company makes a certain profit from each sale of A, and there is a profit (or loss, given overhead) associated with sales made at the rate predicted by Pr(A). There are several costs associated with direct marketing: the cost of targeting (selecting likely customers) if any targeting is done, the cost of the incentive (if any), the cost of the actual mailing or other form of contact. In many cases, Pr(A) and Po(A) are both very small numbers, and there can be little or no marginal profit (or even a loss) associated with either doing nothing and relying on Pr(A) or sending out random mailings of offers and obtaining differential returns of (Po(A)−Pr(A))*N_{mailed} new sales.

In many cases, however, the yield from targeting customers on the basis of a predictive model to obtain returns that are still further improved to Pt(A|˜d,˜t,˜p) can be large enough to increase the marginal return relative to either random selection or untargeted marketing. This is especially likely to be true when there are particular blocks of the population that are either much more or much less likely to purchase A, with or without any offer (blocks that in general are not known at the beginning of a campaign). In some cases, targeting will actually generate a profit instead of a loss or break even with doing nothing at all. In others, targeting may transform a small profit into a much larger one. In a few cases, notably ones where Pr(A) is already rather high and where there is little variation in probability of purchase from individual to individual, targeting can itself result in a loss—the marginal gains can be smaller than the increased costs.

Model performance is crucial to the profitability of any such campaign. Knowledge, especially knowledge of quantities such as Pr(A), is necessary to even do the preliminary cost-benefit analysis that determines the baseline from which model-driven or randomly driven sales acquisition can proceed. Unfortunately, it is all too often the case that little or no data is available at the start of a campaign to permit rational management decisions to be made to optimize profits.

The very first application of the ACE is that it can provide a rough estimate of Pr(A) as a Bayesian prior from the PII-stripped forward map. “Rough” because the two populations involved may not be precisely the same and because the forward map may admix a certain number of offer-driven sales from earlier campaigns by this company or its competitors, so it may interpolate Pr(A) and Po(A) for example. Still, this is often enough to establish a rational baseline of marginal profit expectations that can be further modified by experience gained during the actual campaign(s).

As an illustration, assume that a company decides to proceed with targeted, incentivized campaigns, to be conducted serially for A this month, for B next month, and for C the third month. Initially they have no data connecting individuals with their probability to purchase any one of these products, but the products are all represented in distinct transactional categories in the PII-protected transactional database so that credible estimates for e.g. P(A), P(B), P(B|A), P(B|A), P(A&B) and so on are available, formed by the ACE 704. A model P(B|A)*M(A|d) 705 may be generated from the model 701 for product A and the P(B|A) for the ACE 704.

As an illustration, assume that a company decides to proceed with targeted, incentivized campaigns, to be conducted serially for A this month, for B next month, and for C the third month. Initially they have no data connecting individuals with their probability to purchase any one of these products, but the products are all represented in distinct transactional categories in the PII-protected transactional database so that credible estimates for e.g. P(A), P(B), P(B|A), P(B|A), P(A&B) and so on are available, formed by the ACE 704. A model P(B|A)*M(A|d) 705. may be generated from the model 1001 for product A and the P(B|A) for the ACE 704. This is a model for B that should have positive predictive value compared to random chance that is built without any direct B sales data.

Lacking any information connecting A to any particular customer demographic, random addresses in the targeted area are selected from lists compiled by a vendor that provides a relatively “rich” set of demographic descriptors associated with each address. The offers mailed to those addresses contain an address-specific unique key permitting the cashing of the offer to be positively associated with the address and any other demographic information associated with the address in the primary demographic database. As data on A sales connected with the randomly made offer begins to accumulate, a self-optimizing iterative process can be used to improve the process that includes:

(i) Wait initially until enough tagged sales have occurred that a predictive model M(A|˜d) can be built. “Enough” is a term that must be self-consistently determined as it depends on the dimensionality of the correlated patterns that contribute to the actual probability distribution (which is all unknown) but a rule of thumb is that model generation can at least begin once 100 sales have accumulated.

(ii) Build a predictive model M(A|˜d) using sales data accumulated to date (both positive and negative).

(iii) Use that model to generate a sliding fraction of the targets mailed. Initially, for example, it might be only 10% of the targets (so that the remaining 90% provide a source for more data to improve the model).

(iv) As the model performance improves and more data is accumulated, gradually increase the fraction of targeted addresses up to an upper bound of 95% targeted, 5% random.

(v) Iterate, repeatedly generating new predictive models with results from the random targets as it comes in to gradually increase model performance and maximize profitability.

The ongoing selection of a small fraction of randomly selected targets permit the “lift” associated with the model to be dynamically assessed, while also accumulating more valid statistical data to permit the gradual further improvement of the model. However, this process does not use the PII-free prior information in any direct way. That becomes possible when it is time to build a model for target B, which can be done in parallel with the first process, as shown following presented serially to emphasize the relationships and advantages:

(i) Model B begins with no direct sales data associated with individual demographics, but it does begin with M(AHd)! If P(BA) is either significantly larger than P(B) or significantly smaller than P(B), then one can form an initial model:

M(B|˜d,˜p)=P(B|A)*M(A|˜d))

(P(BA)>P(B)) (1)

M(B|˜d,˜p)=P(B|A)*(M(A|˜d)max−M(A|˜d))

(P(B|A)<P(B)) (2)

This model should outperform random target selection from the beginning as it utilizes known correlations between the transactional target behavior to connect a prior model M(A|˜d) to the desired posterior model.

(ii) Begin as before with perhaps 10% modeled and 90% random targets in the B campaign, and continue as before until enough tagged, random sales have occurred that a second-stage predictive model M′(B|˜d) can be built. In general, this model can be built to correct the prior model in step 1, which means that the patterns already realized in the prior model do not have to be directly inferred from the data. That is:

M(B|˜d,˜p)=P(B|A)*M(A|˜d)+M′(B|˜d)

(P(B|A)>P(B)) (3)

M(B|˜d,˜)=P(B|A)*(M(A|˜d)max−M(A|˜d))+M′(B|˜d)

(P(B|A)<P(B)) (4)

In these expressions M′(B|˜d) 1006 is a modified model for the difference between the prior model alone and the full posterior model. By using the full range of data available, both accumulated in the B campaign, accumulated in the A campaign, and via the PII free correlations generated by the ACE, the posterior model for B in a self-optimizing process cannot be worse than the M(B|˜d) model 1006 one can build using the B campaign sales data alone at any given stage (since generating a model in this latter way is just one of the many options that can be utilized to build the posterior model and optimizing it relative to random selection).

(iii) As before, use the best posterior (i.e., built on the basis of current data, as opposed to built using prior data for something completely different) model(s) currently built to generate a sliding fraction of the targets mailed.

(iv) As the model performance improves and more data is accumulated, gradually increase the fraction of targeted addresses up to an upper bound of 95% targeted, 5% random.

(v) Iterate, repeatedly generating new predictive models with results from the random targets as it comes in to gradually increase model performance and maximize profitability.

Obviously this process can be continued and extended, using the best posterior models for A and B together to create a prior model for C and so on. Furthermore, there is no reason that generating coupled models for A, B, C . . . cannot be carried out in parallel—the process was presented serially only to demonstrate the data dependencies, but since P(B|A), P(C|A&B), etc, are all Bayesian priors that are available at the beginning of the process the information they represent can be used by the ACE in many different ways.

A correlation engine server (e.g., ACE) according to embodiments of the present invention can use a variety of specific modeling methodologies in constructing M(A|˜d) (or P(A|˜d)) and so on above. Some of these are highly traditional and do not constitute a significant aspect of this patent—multivariate logistic regression, for example. One, however, is a very good methodology for generating the direct models from ˜d but is arguably the best methodology for generating prior-corrector coupled models, incorporating the prior information and previous (or parallel) models in an optimal way.

M(B|d,p) is a posterior model for B, built from a prior neural model for A given d M(A|), P(B|A) from the ACE, and more data for B only. This is to be contrasted with directly building P(B|d) from the posterior model data—this is expected to be relatively inaccurate until enough B specific data is accumulated, but the predictor-corrector model begins as accurate as the prior model A combined with the known P(B|A) correlations can make it, and then improves.

FIG. 8 shows a diagram of a two-stage neural posterior model according to an exemplary embodiment of the present invention. The two-stage neural posterior model 800 may include a prior neural model for A 801 that receives PII-free data 803 and a posterior neural model for B 802 that also receives the PII-free data 803. The posterior neural model for B 802 may generate a model M(B|d, p) 806. The ACE 804 along with the prior neural model for A 801 may produce P(B|A)*M(A|d) 805 that may feed into the posterior neural model for B 802. P(B|A) M(A|d) is a model for B. For example, M(A|d) is an estimate of the probability of A given the data. P(BA) is the probability of B given A. The product is an estimate of the probability of B given the data d, built without any explicit B data

According to embodiments of the present invention, this model may be generated by a correlation engine server. This model illustrates an example of the constructive use of PII-derived knowledge in the generating of improved models. The posterior model for B discussed previously was a two-stage model. It involved generating a model that contained partial information on the model sought then integrating that model into a second stage model generation process that corrected the model with new information plus the constraint of the first partial model.

By subtracting out the prior information, e.g. P(B|A)*M(A|˜d) 805 as a constraint, the new data that comes in during the execution of the B model can concentrate on resolving patterns in the complementary space. Unfortunately, very few modeling methodologies are capable of fitting an arbitrary multivariate non-linear function, which is what M(B|˜d,˜p) 806 and M′(B|˜d) both are.

One exception to this general rule is the neural network. Neural networks have precisely the desired properties for fitting an arbitrary multivariate non-linear function. They are entirely general nonlinear multivariate function approximators. Neural networks can manage correlations in high dimension without a priori having to know or guess their form. They can also manage occult covariance on their inputs, more or less automatically creating a decomposition to accommodate it. The model generation process itself automatically determines the important directions and volumes in a high dimensional projective subspace of the inputs. Bayesian prior information—even if it is a direct model for the targeted behavior—is just another input to a correlation engine server for the model generation process for a neural network.

There is really no limit to the amount or kind of Bayesian prior information that can be input to a multistage neural network model generation process in this way. In a correlation engine server (e.g., ACE), the Bayesian prior information may be effectively a set of joint probability distributions (or models) or any other prior information, heuristic or otherwise, one wishes to supply the engine with. Any set of proxy models that project into the prior correlations become a candidate for direct, correlated input into the model generation process; any set of heuristics or “prior bias” on the part of the model builder can be so incorporated, and the process of generation the second (or higher) stage model will automatically correct any incorrect heuristics as the data supports the correction while using the heuristic to improve the resolution of new details where it works.

This makes a small change in the outline for general correlated models above. The architecture of a multistage neural network is illustrated above; the primary difference is that instead of directly forming a linear correction model M′(B|˜d) of some assumed form (such as simple addition with a prior model for A conditioned by the prior correlation between A and B) the entire posterior model is built using neural methodology (e.g., genetic optimization and conjugate gradient methods) from the single set of data accumulated on the sales of B once the A model (also built as a neural network from the same neurification of the date vector ˜d) is known. A correlation engine server (ACE) according to embodiments of the present invention may be configured to:

(i) Build a neural model for A using (random) sales data that maps demographic data ˜d into sales propensity M(A|˜d).

(ii) Given (random) sales data that maps demographic data ˜d drawn from the same population but not necessarily overlapping at all on an individual basis, generate M(AHd) for each individual in the sales data.

(iii) Multiply this model score by the estimated PII-free P(B|A) from the ACE, normalizing as necessarily with P(A) and P(B) (also estimated from the ACE).

(iv) Transform this score into a (possibly vector) form ˜p suitable for use as input for the second stage network.

(v) Use both ˜d and the computed value ˜p(˜d) as input to a process of generating a classification network for the propensity to buy B.

FIG. 9 shows a diagram of a system for generating anonymous correlations between publication-restricted data and personal attribute data according to another exemplary embodiment of the present invention. The system 900 may include a correlation engine 901, one or more transaction servers 902, 903, 904 and one or more modeling servers 905, 906, 907. The correlation engine 901 may receive transactional data from each of the one or more transaction servers 902, 903, 904 and demographic data from each of the one or more modeling servers 905, 906, 907. The correlation engine 901 may use the transactional data and/or the demographic data to generate an inverse map and a forward map. The inverse map and the forward map may be used by the correlation engine 901 to generate a unified map. The correlation engine 901 may use the inverse map and/or the forward map and/or the unified map to generate predictive models, proxy/correlated models, parzen-bayes network models and/or multistage neural network models. The generated inverse map may be sent to the one or more transaction servers 902, 903, 904 by the correlation engine 901. The generated forward map may be sent to the one or more modeling servers 905, 906, 907 by the correlation engine 901.

The advantages of embodiments according to the present invention are profound. First, the neural network build algorithm will quickly learn that P(B|A)*M(A|˜d) 1105 is a good indicator of M(B|˜d if P(B|A) (true) is significantly different from random chance either way. This is especially true if P(BA) is very different from P(B), for example if all purchasers of A are certain to buy B as well the model generation process is certain to discover this and pipe the A model result straight through to the output, only slightly modified and further improved by the new B data.

The same is true if it is certain that purchasers of A will not purchase B, except that one doesn't have to construct an ad-hoc model via subtraction in this case, the model generation process will automatically generate the required inversion and scale it and further correct it on the basis of the data.

This is true even if the corrections take on complex logical or set theoretic forms. For example, suppose that there is a strong correlation between A and B purchasers, where most of the former also the latter. The exceptions, however, have a characteristic demographic pattern. Individuals with this pattern may not all be unlikely to purchase B, however, but the neural network build will, as data permits it, determine these patterns and correct the model in exclusive or ways that are almost impossible to realize with non-neural methodologies, e.g. logistic models.

The contents of ˜p are not limited to single models, and in fact models can be multilayered, with M(B|˜d,˜p), M(A|˜d,˜p) (both formed in parallel using each other as a self-consistent cross-over prior) can be used to form M(C|˜d,˜p) where ˜p contains model predictions from both improved models for A and B, and the C model can similarly be looped back to further improve the A and B models to the extent permitted by the random data available for all three.

Heuristics can also be added to ˜p. This can be as simple as adding a strong belief that most purchasers of a product will be in some particular age range—say 18 to 30—or as complex as providing the final model generation stage with an entire function F(˜d) that one expects to form an important part of the solution.

According to embodiments of the present invention, a correlation engine server may be configured to generate predictive models especially suitable when data sampling the targeted population is sparse (e.g., Parzen-Bayes networks). In this case a classification model can be built from the data by using the data points in a space of modest dimensionality to act as self-consistent predictors of class membership using a tensor metric and, e.g., a Gaussian centered on each point to partition the volume into likely membership classes. The best fit (given a set of data) is generally the one that finds the metric tensor and dimensional Gaussian widths that maximizes the data's self-prediction in a jackknife computation (where N−1 individuals are used to predict the correct classification of the remaining 1, averaged over each omitted member)).

As noted previously, knowledge of P(B|A) and P(A|B) and so on from the ACE can significantly improve the construction of the resulting classification scheme if it is used to weight points for or against membership in one class given only membership in one of the others. With sparse data this is especially important, as it may take a rather long time to accumulate enough data points to resolve things like individuals who are likely to be in both A and B, in A but not B, in B but not A, or in neither one. This latter class is of especial interest. This particular model-generation methodology takes a set of data that typically all belong to one of the classes of interest, for example, it may be able to give you a score or set of scores monotonically related to the probability that a given individual to whom the model is applied as one of several diseases, or will benefit from one of several therapies. However, the model will typically not contain the raw probability of any randomly selected individual having any of the diseases—the prevalence of the diseases in the population.

As any person with knowledge of Bayesian statistics knows, without this number one can make enormous mistakes in any sort of classification scheme. This is sufficiently true that it has become an adage in the medical community: “if you hear hoof-beats, think horses, not zebras”. What this means is that if you have an individual with symptoms that could equally well indicate that the individual has a mundane and common disease (say a simple stomach virus) and a much less common disease (say cholera), it is far more probable that the individual has the common disease, not the uncommon one, even though the symptoms alone give you no reason to prefer one to the other.

In this case, the “prior” knowledge is the accumulated knowledge of the medical community on the prevalence of most diseases and the correct thing to do with this knowledge is reduced to a simple heuristic that is further modified by judgment born of experience in each physician that applies it. In the case of the ACE, the PII-free prior knowledge can be built more generally from any large database of PII-dressed information (stripping it off in the process so that no individual can be identified in the resulting matrices of “joint prevalence” in some population, but the application is just the same as in the case of this adage—the simple landscape of clustered attractors that results from a using points in a highly non-representative dataset as their base can be modified with regions lifted up and others pushed down according to the prior knowledge of mutual prevalence, so that the model correctly assumes that hoof-beats are horses even though the data used to build it was a non-proportional admixture of horse data and zebra data intended to give the model the best chance of resolving the rare zebras that do come along. A correlation engine server (ACE) according to embodiments of the present invention may be configured to:

(i) Build a suitable, sparse, dataset using as many exemplars of the classes one wishes to resolve as possible, taking some trouble to balance them and thereby avoid introducing a sample bias caused by having differential access to individuals in some particular class that may not reflect numbers in the general population.

(ii) Build from this dataset a Parzen-Bayes network—construct overlapping Gaussians centered on each data point, with variable metrics and/or Gaussian widths per input dimension.

(iii) Sum them (per target class) and vary the dimensional tensor metrics in such a way that the model maximally predicts its own classification in a jackknife where each member of the dataset is omitted, one at a time.

(iv) Reweight the class model scores using a Bayesian reduction of the PII-free priors for the classes, raising them or diminishing them according first to their raw prevalence (more or less renormalizing the model) and then according to patterns such as P(A|B)*M(B|˜d) as before. This, too, has to be carefully done in order to correct, in as unbiased a way as possible, for the bias in the selection of the original data set.

Embodiments of a correlation engine server according to the present invention may be utilized within the general practice of predictive model generation and permit “private” personal data (e.g., transactional data or health data associated with individuals), to be aggregated and transformed so that no trace of personal information remains. Embodiments of a correlation engine server according to the present invention and associated processes enable the usage of non-personal information derived from databases containing some admixture of personal information without violating privacy protecting laws, practices or customs in both the business and general science community to build valuable predictive models. In the business case, the resulting data objects produced by embodiments of a correlation engine server according to the present invention may describe correlations in typical transactional behavior averaged over a large population, not any specific transaction that is derived from or associated with any individual in the originating database. In the case of health care data, it might describe correlations in typical patterns of disease averaged over a large population, while at the same time containing no data on any specific individual. In both cases this correlation structure—in general a tensor of second or higher rank—can be sold, published, freely transferred in public or private transactions. It is no more personal than a statement by a bank that “sixty percent of homeowners that have a mortgage with us also have a home equity line of credit” (a statement that might well appear in an annual report without violating banking privacy laws), or “seventy three percent of all hospitalized cancer patients at one time smoked cigarettes regularly” (which in no way violates medical privacy laws).

Both are undeniably valuable information, information of benefit to either the bank and its investors or society as a whole, that cannot now be readily derived from databases with mixed PII and non-PII because of a lack of devices and procedures that provably remove their PII component and precisely yield PII-free statistical correlations that permit useful inferences to be made in all directions.

A correlation engine server according to embodiments of the present invention provides tremendous prospective value since the Gramm-Leach-Bliley Act (GLBA) has effectively blocked all use of the immense and valuable aggregated information that is in the possession of many financial institutions because they have not been able to solve the problems solved by embodiments of the present invention. Similarly, demographic studies in health care have been heavily suppressed by the requirements of the Health Insurance Portability and Accountability Act (HIPAA). Every patient must be enrolled for every study independent of all other studies for all other aspects of health care that were ever conducted with their own expensive population of enrolled patients.

A correlation engine server according to embodiments of the present invention generates internal anonymous aggregates of tensor correlations between many important degrees of freedom, e.g., transactional or health behaviors that are strongly correlated with other projective components, allowing the use of all the prior knowledge derived from all the models or studies that have been conducted when generating any current model, with the confidence that the resulting model will almost certainly be more predictive with less supporting data, as relationships that would otherwise have to be weakly inferred from that supporting data are presented to the model generation process in a preprocessed form where the information content is already directly accessible to a secondary implicit optimization process.

A correlation engine server according to embodiments of the present invention executes the model generation processes as described above thus making optimum use of all information that is permissioned to be used in any given application. A correlation engine server according to embodiments of the present invention performs the unique processes necessary to transform an arbitrary dataset with privacy-derived constraints into a form that can support predictive modeling driven by an arbitrary source of permissioned data, and may also process reverse inferences on the private data or improve forward inferences based on the public data.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1-21. (canceled)

22. A correlation engine apparatus comprising a network interface; and a processor; wherein the correlation engine is configured to receive publication-restricted data and non-publication-restricted data and generate correlations useable for predictive models, wherein no trace of any personal identifying information (PII) in the publication-restricted data exists in the correlations.
